(19) United States
(12) Patent Application Publication
(10) Pub. No.: US 2007/0269666 A1
(43) Pub. Date: Nov. 22, 2007

(54) COMPOSITION FOR TREATING METAL SURFACES

(76) Inventor: Michael Andrus, Hurricane, UT (US)

Correspondence Address: HOVEY WILLIAMS LLP, 2405 GRAND BLVD., SUITE 400, KANSAS CITY, MO, 64108, US

(21) Appl. No.: 11/419,385

(22) Filed: May 19, 2006

(51) Int. Cl. B32B 9/00; C08J 5/12; B05D 1/02; B05D 1/18

(52) U.S. Cl. 428/469; 428/698; 106/287.3; 427/427.1; 427/430.1

(57) ABSTRACT

Improved methods for treating metal surfaces, and especially soft metal aluminum or magnesium surfaces, involves contacting such surfaces with an aqueous mixture or composition containing boron nitride at acidic or basic pH levels. Preferably, aluminum concrete form sections are treated using an aqueous boron nitride composition including potassium hydroxide and having a pH of from about 12-14. Such forms are treated by spraying or similar methods resulting in a chemical reaction between the boron nitride and metal.

### BACKGROUND OF THE INVENTION

1. Field of the Invention

The present invention is broadly concerned with methods for treatment of metal surfaces in order to improve the smoothness of the surface and the surface's resistance to corrosion. More particularly, it is concerned with such methods, treatment compositions, and the resultant treated metal bodies, wherein the metal surfaces are treated with an aqueous mixture containing boron nitride at acidic or basic pH levels, in order to induce a chemical reaction between the boron nitride and the metal surface. In preferred embodiments, aluminum concrete form sections are boron nitride treated to increase the resistance to degradation owing to the alkaline nature of concrete.

2. Description of the Prior Art

Aluminum concrete forms are widely used for the fabrication of basement walls or entire concrete structures. These forms are commonly made up of a series of interconnected aluminum panels cooperatively defining upright forms which receive concrete. After the concrete hardens, the forms are removed for reuse.

A persistent problem with aluminum concrete forms is the damage done to the form surfaces because of the alkaline nature of the concrete used. Thus, the form sections over time become pitted and uneven, leading to formed walls having correspondingly pitted or deformed outer surfaces. This problem has remained essentially unsolved for many years, owing to the lack of any effective treatment of the form sections at a reasonable cost. Thus, it has been suggested to treat the aluminum form sections by plating with various substances which may include boron. While such techniques may give a measure of improvement, the cost thereof is considerable, to the point that it is often cheaper to replace the form sections after a period of use than to plate them for a longer useful life.

Boron nitride is a binary chemical compound having equal proportions of boron and nitrogen and the formula BN. Structurally, boron nitride is isoelectronic to carbon and takes on similar physical forms such as hexagonal, graphite-like, and cubic. Boron nitride is one of the hardest materials known, behind only diamond, ultrahard fullerite, and aggregated diamond nanorods. It is widely used for grinding and as a material for tools in industry. This is in part because boron nitride does not dissolve into iron, nickel, and related alloys at high temperatures. Boron nitride generally exists as an insoluble white solid having a density of about 2.2×10³ kg/m³.

Boron nitride has been used to coat or otherwise treat metals, see, e.g., U.S. Pat. Nos. 6,576,330, 6,458,423, 6,737,120, and 4,282,012.

### SUMMARY OF THE INVENTION

The present invention overcomes the problems outlined above and provides improved methods for treating metal surfaces comprising contacting such surfaces with an aqueous mixture or composition containing boron nitride and having a pH of less than about 6 or above about 8. Preferably, the pH is basic, ranging above about 10 or more preferably from about 12-14. A strong base is normally used to achieve such pH levels, typically a hydroxide and most especially potassium hydroxide. The treating composition is preferably a true solution and has a water-like consistency with the boron nitride essentially completely solubilized therein.

The metal surface treatments of the invention generally involve spraying, wiping, or dipping the metal surfaces using the treatment compositions, so long as the surfaces in question are fully wetted. During the course of the treatment, a chemical reaction occurs between the boron nitride and the metal surface forming a corrosion-resistant, smooth protective layer with the metal surface. In preferred embodiments, the boron nitride reacts with the metal surface without any annealing, heat treatment, or plating operation. The metal surface formed is thus not annealed and not plated with boron nitride. The invention is particularly advantageous for the at or near ambient temperature treatment of metal bodies especially aluminum concrete form section surfaces, vehicle body panel surfaces, metal tool surfaces, aluminum structural components, marine applications, processing equipment applications, and any other surface that is regularly exposed to corrosive conditions. By treating under ambient or near ambient conditions, treatment of the metal surface may occur practically anywhere, particularly proximate the final end use location of the metal body, such as the job site or in the field.

In yet another embodiment, the boron nitride mixture for application to the metal surfaces is an aqueous solution consisting essentially of water, boron nitride and an alkali metal base, preferably potassium hydroxide. No binders, stabilizers or further additives are required to be mixed with the boron nitride solution.

In still another embodiment, the metal surfaces to be treated with the boron nitride mixture or composition comprise metal sheets or plates that can be formed into monolithic shapes (i.e., as with the concrete form sections), or molded into parts for use as tools or automotive wheel well or underbody panels. Additional surfaces that may be treated include marine vessel components, aluminum building materials, and processing equipment such as tanks, mixers, and conduits.

### DETAILED DESCRIPTION OF THE PREFERRED EMBODIMENT

As outlined above, the methods of the present invention are particularly suited for the treatment of aluminum concrete form sections. In such context, the invention reduces the wear and pitting commonly encountered with such forms.

In one particularly preferred embodiment, a 55-gallon batch of a form-coating solution was made using 10.25 gallons of clear household ammonia, 31.00 gallons of water, 24.20 pounds of boric acid powder, and 13.75 gallons of 50% potassium hydroxide. A mixing tank was initially charged with the ammonia and water, and while blending the boric acid added with mixing for a period of 15 minutes or until the powder was completely dissolved. The potassium hydroxide was then added with mixing to achieve a uniform blend having a pH of about 14. The boric acid and ammonia reacted in the tank to form boron nitride by the reaction

H₃BO₃+NH₃→BN+3H₂O.

The boron nitride mixture was then applied to the surfaces of aluminum concrete form sections by spraying, approximately at the level of 1 gallon mixture per 350 square feet of section. The spraying was done under ambient conditions, and the mixture was allowed to react with the aluminum form section for a period of time. The form section was rinsed before the boron nitride solution could dry completely. This process resulted in formation of a protective layer on the surface owing to a chemical reaction between the boron nitride and the aluminum and/or aluminum oxide at the surface of the sections. Rinsing of the surface before the boron nitride solution is allowed to dry results in a much smoother treated surface than if the solution is allowed to dry. Rinsing of the surface is less important when the primary objective in treatment is the formation of a corrosion resistant surface.

A plate of aluminum alloy 5051 was treated with the composition described above by dipping. The treated sample and an untreated control underwent Vickers microhardness testing using a Leco M 400 F Vickers microhardness tester. Samples were trimmed from each of the treated and untreated plates and the surfaces polished in accordance with ASTM specification E384. Each sample was clamped into the microhardness tester and five indentations were made using a load of 200 g. The indentations were measured at 400× magnification to give a Vickers hardness number. All five indentations were taken proximate the center of the sample.

The test procedure was repeated using additional samples trimmed from the treated and untreated plates without polishing the surfaces of the samples in case the polishing removed the boron nitride protective layer. The results of the testing are given in the table below.

| | | | | |
|---|---|---|---|---|
| | | | | Vickers |
| Test Number | Diagonal 1 | Diagonal 2 | Average Diagonal | Number |

5051 Treated Aluminum Alloy Polished

| | | | | |
|---|---|---|---|---|
| 1 | 132.5 | 130.4 | 131.5 | 86 |
| 2 | 128.8 | 129.8 | 129.3 | 89 |
| 3 | 130.7 | 132.9 | 131.8 | 85 |
| 4 | 127.2 | 135.3 | 131.3 | 86 |
| 5 | 131.1 | 131.0 | 131.1 | 86 |

Average Vickers Number: 86

5051 Untreated Aluminum Alloy Polished

| | | | | |
|---|---|---|---|---|
| 1 | 131.8 | 131.8 | 131.8 | 85 |
| 2 | 131.3 | 132.0 | 131.7 | 86 |
| 3 | 129.9 | 133.7 | 131.8 | 85 |
| 4 | 127.0 | 136.0 | 131.5 | 86 |
| 5 | 126.0 | 132.8 | 129.4 | 89 |

Average Vickers Number: 86

5051 Treated Aluminum Alloy Unpolished

| | | | | |
|---|---|---|---|---|
| 1 | 159.8 | 161.3 | 160.6 | 58 |
| 2 | 159.2 | 164.8 | 162.0 | 57 |
| 3 | 160.0 | 163.4 | 161.7 | 57 |
| 4 | 158.4 | 157.8 | 158.1 | 59 |
| 5 | 159.8 | 161.1 | 160.5 | 58 |

Average Vickers Number: 58

5051 Untreated Aluminum Alloy Unpolished

| | | | | |
|---|---|---|---|---|
| 1 | 157.8 | 161.3 | 159.6 | 58 |
| 2 | 158.6 | 161.9 | 160.3 | 58 |
| 3 | 160.0 | 165.0 | 162.5 | 56 |
| 4 | 156.1 | 159.8 | 158.0 | 59 |
| 5 | 157.4 | 166.8 | 162.1 | 56 |

Average Vickers Number: 58

The results of the Vickers microhardness testing revealed several surprising results. Prior to testing, it was expected that the samples treated with boron nitride would yield higher hardness values than the untreated samples. However, this was not the case as the treated and untreated samples exhibited identical average Vickers numbers. It was also expected prior to testing that the unpolished treated sample would exhibit a higher hardness value than the polished treated sample given the likelihood that the protective boron nitride layer would be removed by the polishing step. Again, this was not shown to be the case as the unpolished sample exhibited a lower hardness value than the polished sample.

While the above-described technique is highly useful and inexpensive, the invention is not limited to this example. Hence, industrial strength ammonia may be used in lieu of household ammonia and other acids or bases may be employed instead of potassium hydroxide. For example, other alkali or alkaline earth metal hydroxides may be capable of facilitating the reaction between boron nitride and the metal surface, particularly sodium hydroxide and lithium hydroxide. However, such materials (i.e., LiOH and NaOH) are not preferred, and the usage thereof is most preferably avoided as they can damage the surfaces that the present invention seeks to protect. Further, it would be possible to purchase boron nitride rather than create it in situ, in which case the acid or base would be added to an aqueous mixture of the boron nitride.

Other alternatives include the pH levels of the coating mixture, broadly less than about 6 or above about 8, more preferably above about 10, and most preferably from about 12-14. The preferred coating mixture is a true solution and includes a hydroxide base therein, most especially potassium hydroxide. The boron nitride should be present in the coating mixture at a level of from about 0.5-10% by weight, more preferably from about 1-8% by weight, and most preferably from about 1.45-4.45% by weight.

The solution may be applied to metal surfaces using a variety of techniques, for example spraying or wiping the metal surface with the mixture, or dipping the metal surface in the mixture; for treatment of concrete form sections, spraying is the preferred alternative. The application of the coating mixture may be carried out under normal ambient conditions without subjecting the surface to high temperature treatment. Preferably, the ambient temperatures should be at least about 40° F. and more preferably between about 40-120° F. The mixture is generally applied at a level of about 100-600 square feet/gallon, and more preferably from about 250-500 square feet/gallon. The coating mixture is either allowed to dry on the metal surface, usually under ambient conditions, or rinsed from the surface after a sufficient reaction time.

During the coating/drying process, the boron nitride of the mixture chemically reacts with the metal surface to form a protective coating thereon. This coating normally has a thickness of about 0.5-5 thousandths of an inch, more preferably about 1-2 thousandths of an inch. In the case of aluminum, the boron nitride reacts with the aluminum and/or aluminum oxide present at the surface to create the protective surface layer.

The methods of the invention may be used to treat a variety of metals, but normally the softer metals, such as aluminum, aluminum alloys, magnesium, magnesium alloys, and mixtures thereof are best suited for such treatments. Harder metals typically require a greater concentration of potassium hydroxide in the treating mixtures to achieve the desired results.

I claim:

1. A method of treating a metal surface comprising the step of contacting said metal surface with an aqueous mixture containing boron nitride and having a pH of less than about 6 or above about 8.

2. The method of claim 1, said pH being above about 10.

3. The method of claim 1, said mixture including a hydroxide base therein.

4. The method of claim 3, said hydroxide base being potassium hydroxide.

5. The method of claim 1, said boron nitride being present in said mixture at a level of from about 0.5-10% by weight.

6. The method of claim 1, said contacting step selected from the group consisting of spraying and wiping said surface with said mixture, and dipping said metal surface in said mixture.

7. The method of claim 1, said contacting step being carried out at a temperature between about 40 to about 120° F.

8. The method of claim 1, said metal surface selected from the group consisting of aluminum, aluminum alloys, magnesium, magnesium alloys, and mixtures thereof.

9. The method of claim 1, said mixture being contacted with said metal surface at a level of from about 100-600 square feet/gallon.

10. The method of claim 1, said boron nitride of said mixture reacting with said metal surface to form a protective layer thereon.

11. The method of claim 10, said protective layer having a thickness of from about 0.5-5 thousandths of an inch.

12. The method of claim 1, said metal surface being selected from the group consisting of aluminum concrete form section surfaces, vehicle body panel surfaces, metal tool surfaces, aluminum structural components, marine applications, and processing equipment applications.

13. A body having a metal surface, said metal surface contacted with an aqueous mixture containing boron nitride and having a pH of less than about 6 or above about 8.

14. The body of claim 13, said body being selected from the group consisting of aluminum concrete form section surfaces, vehicle body panel surfaces, metal tool surfaces, aluminum structural components, marine applications, and processing equipment applications.

15. The body of claim 13, said mixture including a hydroxide base therein.

16. The body of claim 15, said hydroxide base being potassium hydroxide.

17. The body of claim 13, said metal surface selected from the group consisting of aluminum, aluminum alloys, magnesium, magnesium alloys, and mixtures thereof.

18. The body of claim 13, said boron nitride of said mixture reacting with said metal surface to form a protective layer thereon.

19. The body of claim 18, said protective layer having a thickness of from about 0.5-5 thousandths of an inch.

20. An aqueous solution for application to metal surfaces comprising water, boron nitride, and sufficient acid or base to give the composition a pH of below about 6 or above about 8.

21. The solution of claim 20, said pH being above about 10.

22. The solution of claim 20, said solution including a hydroxide base therein.

23. The solution of claim 22, said hydroxide base being potassium hydroxide.

24. The solution of claim 21, said boron nitride being present in said solution at a level of from about 0.5-10% by weight.
